(19) United States
(12) Patent Application Publication
(10) Pub. No.: US 2005/0114587 A1
(43) Pub. Date: May 26, 2005

(54) ExpressCard with On-Card Flash Memory with Shared Flash-Control Bus but Separate Ready Lines

(75) Inventors: Horng-Yee Chou, Palo Alto, CA (US); Sun-Teck See, San Jose, CA (US); Tzu-Yih Chu, San Jose, CA (US)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 10/707,138

(22) Filed: Nov. 22, 2003

(51) Int. Cl. G06F 12/00

(52) U.S. Cl. 711/103

(57) ABSTRACT

An ExpressCard contains flash memory. The ExpressCard has an ExpressCard connector that plugs into a host, such as a personal computer, digital camera, or personal digital assistant (PDA). A controller chip on the ExpressCard uses a pair of differential Universal-Serial-Bus (USB) data lines in the connector to communicate with the USB host, or can use PCI Express, Firewire, or other protocols. One or more flash-memory chips on the ExpressCard are controlled by a flash-memory controller in the controller chip. Two or more channels of a flash bus have a shared control bus but separate ready lines. The separate ready lines allow flash-memory chips in the two channels to finish operations at different times.

### BACKGROUND OF INVENTION

This invention relates to flash-memory cards, and more particularly to ExpressCard flash cards with dual flash channels.

Flash memory is widely used for storing data in certain applications. Flash memory is especially useful for mobile and non-volatile applications, such as for portable or handheld devices. Flash memory is often more convenient than traditional mass storage devices such as hard disks. Flash memory also offers low power consumption, reliability, small size, and high speed.

Flash memory is non-volatile, since it retains stored data even after power is turned off. This is an improvement over standard random access memory (RAM), which is volatile and therefore looses stored data when power is turned disconnected.

Universal-Serial-Bus (USB) is a widely used serial-interface standard for connecting external devices to a host such as a personal computer (PC). Another new standard is PCI Express, which is an extension of Peripheral Component Interconnect (PCI). An intent of PCI Express is to preserve and re-use PCI software.

As the number of mobile, portable, and handheld devices grows the popularity of flash memory increases. The most common type of flash memory is in the form of a removable memory card. This card allows the contents of the flash memory to be transferred easily between devices or computers.

However, when moving the flash memory card between devices, an additional host, reader, or adapter is often required for the host to communicate with the flash card. Many devices may not have the built-in ability to connect to a flash card, therefore a special adapter or card must be installed in the host device. In addition, the bus architecture can limit the speed of data transfer between the host and flash memory device.

FIGS. 1A-B show an ExpressCard. A new removable-card form-factor known as ExpressCard is being developed by the Personal-Computer Memory Card International Association (PCMCIA), PCI, and USB standards groups. ExpressCard 30 is about 75 mm long, 34 mm wide, and 5 mm thick and has ExpressCard connector 42, which fits a connector on a host when ExpressCard 30 is inserted into an ExpressCard slot on the host. The underside is shown in FIG. 1A while a top view is shown in FIG. 1B.

FIG. 2 shows an enlarged version of ExpressCard. Some card applications may not fit in the small size of ExpressCard 30 of FIGS. 1A-B, so an enlarged card size is also provided. ExpressCard 30′ is also 75 mm long and has the same ExpressCard connector 42, but is wider (54 mm) at the opposite end from connector 42. The cutout notch from connector 42 to the wider part of the card is 22 mm deep. ExpressCard 30′ is about 5 mm thick.

FIG. 3 shows an ExpressCard interface to a host. A 26-pin connector is used to connect ExpressCard 30 to a host such as a PC. Power controller chip 34 receives power and ground supplies and various sensing and reset signals, and generates a Vcc power supply (such as 3.3 Volts) to ExpressCard 30. Other voltages such as 1.5 volts can be generated by power controller chip 34 and supplied to ExpressCard 30. Multiple power and ground pins in the ExpressCard connector can improve signal quality and provide shielding. Clock and wake signals can also be provided to ExpressCard 30. Wake signal WAKE_REQ can be pulled high by a resistor on the host and pulled low by ExpressCard 30 to detect the presence of ExpressCard 30 in a slot on the host.

ExpressCard 30 can use a System-Management Bus (SMB) bus to transfer data to the host. Data and clock signals to and from ExpressCard 30 are coupled to SM bus controller 36. PCI Express data is transferred using the differential pair of PCI Express Transmit lines (PET) and the differential pair of PCI Express Receive lines (PER). Signal CPUSB# can be used for a CPU side-band.

ExpressCard 30 can also use USB to communicate with the host. Differential USB data signals USBD+ and USBD− are connected between ExpressCard 30 and host chip set 32. Host chip set 32 contains a USB host controller to facilitate communication with ExpressCard 30.

What is desired is an ExpressCard with flash-memory for data storage. An ExpressCard with an efficient flash-memory controller is desirable. An ExpressCard flash device that uses USB or PCI Express for communicating with a host is desired.

### BRIEF DESCRIPTION OF DRAWINGS

FIGS. 1A-B show an ExpressCard.

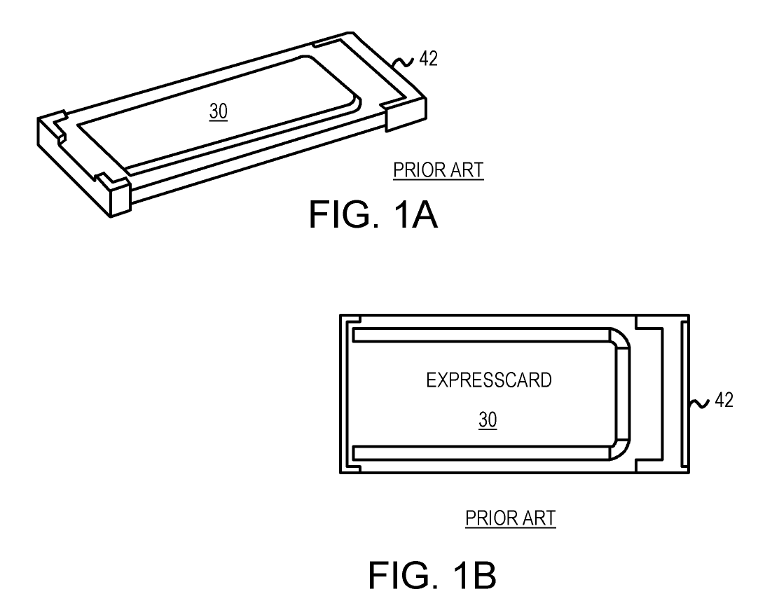

FIG. 2 shows an enlarged version of ExpressCard.

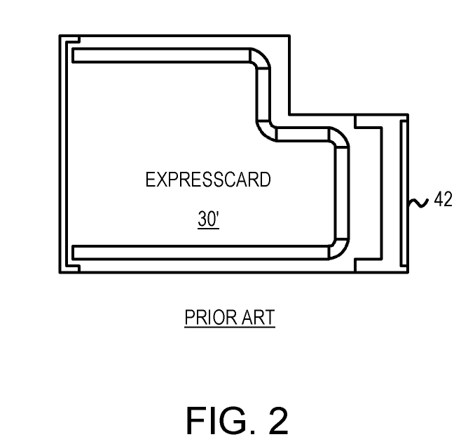

FIG. 3 shows an ExpressCard interface to a host.

FIG. 4 is a block diagram of a flash-memory ExpressCard.

FIG. 5 shows the flash-memory ExpressCard controller in more detail.

FIG. 6 shows two channels between the flash controller and the flash-memory chips on the ExpressCard.

FIG. 7 shows two channels of flash-memory chips with a shared control bus but separate ready lines.

FIG. 8 shows an embodiment using open-drain ready lines.

FIG. 9 shows an embodiment with four flash-memory chips in two channels.

FIG. 10 shows another embodiment with two independent channels and interleaving within each channel.

### DETAILED DESCRIPTION

The present invention relates to an improvement in flash memory cards. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

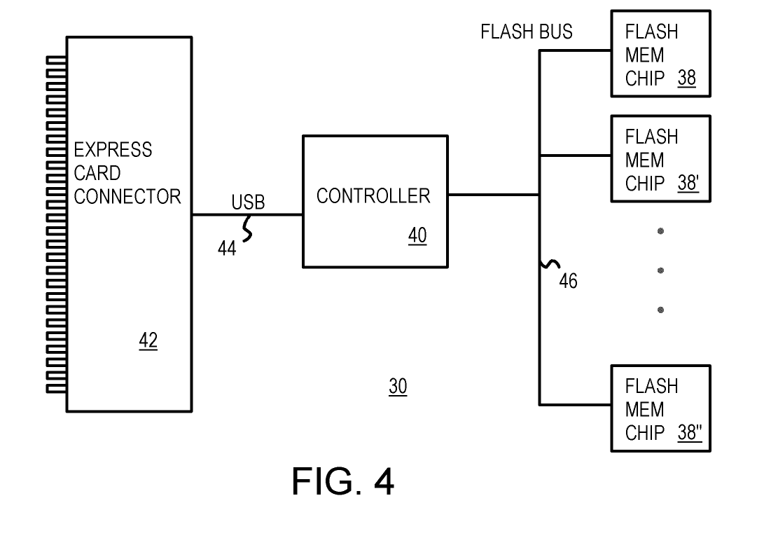

FIG. 4 is a block diagram of a flash-memory ExpressCard. ExpressCard connector 42 plugs into an ExpressCard socket on a host, such as a PC, digital camera, PDA, music player, etc. While ExpressCard connector 42 has 26 electrical connector leads (“pins”), only four leads are needed for USB transfers—the differential USB data lines USBD+ and USBD−, and power and ground.

Controller 40 connects to ExpressCard connector 42 over bus 44, which has the differential USB lines when controller 40 uses the USB protocol for host transfers. Other protocols, such as PCI Express, could use other signals in ExpressCard connector 42. Controller 40 acts as a USB slave device, accepting and decoding commands from the host and responding to these commands, such as by transferring data or providing status information to the host.

Controller 40 can be a custom or semi-custom chip that contains all control functions for ExpressCard 30. Data from the host can be stored in flash-memory chips 38, 38′, . . . 38″. Some ExpressCard 30 may have only one flash-memory chip 38 while others have multiple chips.

Flash bus 46 connects controller 40 to flash-memory chips 38, 38′, 38″. Flash bus 46 contains control signals and data signals, such as 8 bits of data. Commands and addresses can be sent as data over flash bus 46.

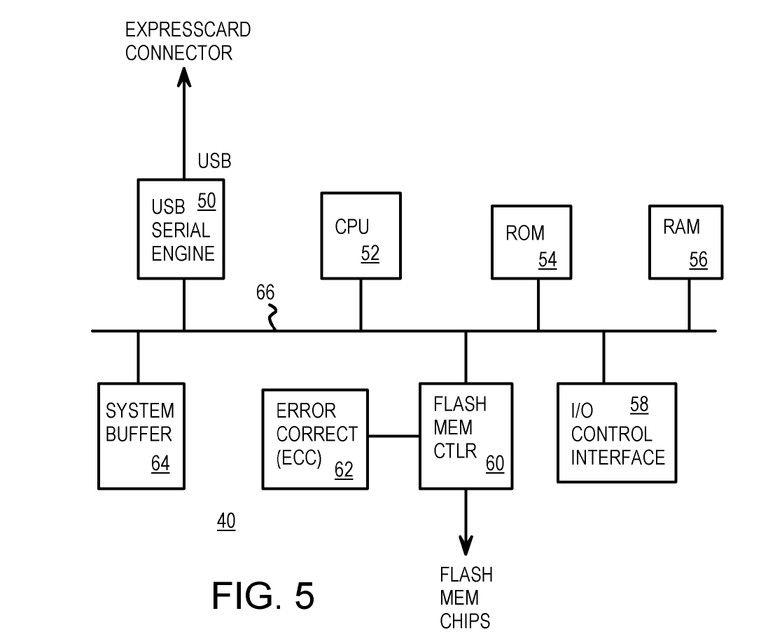

FIG. 5 shows the flash-memory ExpressCard controller in more detail. Controller 40 can be a single-chip micro-controller based on microprocessor CPU 52, which can be an 8051 (8-bit), 80186 (16 bits), ARM CPU(32 bits), MIPS CPU(32/64 bits), etc. microprocessor core. Internal bus 66 connects CPU 52 with other blocks, such as read-only memory (ROM) 54, which can store program code executed by CPU 52, and RAM 56 which can be used by CPU 52 as a scratch-pad or parameter memory.

I/O control interface 58 can have I/O registers that drive external pins of controller 40, and can be used to drive status LED's or detect when a write-protect switch is engaged. CPU 52 can write to these I/O registers to turn an LED on or off (or blink the LED) to indicate when a write to flash-memory on the ExpressCard is in progress.

Serial engine 50 contains logic to receive USB commands sent over the differential USB data lines from the host through the ExpressCard connector. The serial data is converted to parallel data words and stored in system buffer 64 or first in a FIFO memory in serial engine 50. Serial engine 50 controls the transfer of data to and from the ExpressCard connector over the USB data lines. When a command is detected on the USB data lines by serial engine 50, an interrupt to CPU 52 can be generated, allowing CPU 52 to read the command's data or parameters from serial engine 50 and perform the requested function.

CPU 52 can move data from serial engine 50 to system buffer 64, or can activate a direct-memory access (DMA) engine (not shown) to perform the transfer. System buffer 64 can act as a buffer, storing data from the host before it is written to the flash-memory chips. System buffer 64 can also act as a cache, storing data that was earlier read from the flash-memory chips by flash controller 60 and making this data available more rapidly. Various read-ahead caching schemes can be implemented with the cache in system buffer 64.

Commands received from the host by serial engine 50 are decoded by CPU 52 and can include erase, write, and read commands for various sizes of data. CPU 52 performs these commands by sending addresses and internal high-level commands to flash controller 60, which contains state machines and counters to generate the proper low-level commands and timing required by the flash memory chips and perform these functions on blocks or pages of data in the flash memory chips. Flash controller 60 generates the necessary memory-control signals and chip commands such as chip selects, strobes, and read/write/erase commands, and keeps track of the current data byte being accessed or block begin erased. Memory mapping can be performed by CPU 52 to re-map pages of data and improve wear-leveling of memory locations in the flash-memory chips.

Some errors in the data stored in the flash memory chips can be corrected using error-correction code (ECC). As data is being written to the flash-memory chips, ECC generator 62 generates a multi-bit syndrome or ECC word to append to the data. The data together with this ECC word are then sent to the flash-memory chips by flash controller 60 for storage. When the data is read back from the flash-memory chips by flash controller 60, this ECC word is stripped off the data and checked. When an error is detected, ECC generator 62 may correct the data word before the data is sent over internal bus 66 to system buffer 64. Alternatively, CPU 52 can be informed of ECC error details, and CPU 52 can correct the data before (or after) the data is sent to system buffer 64.

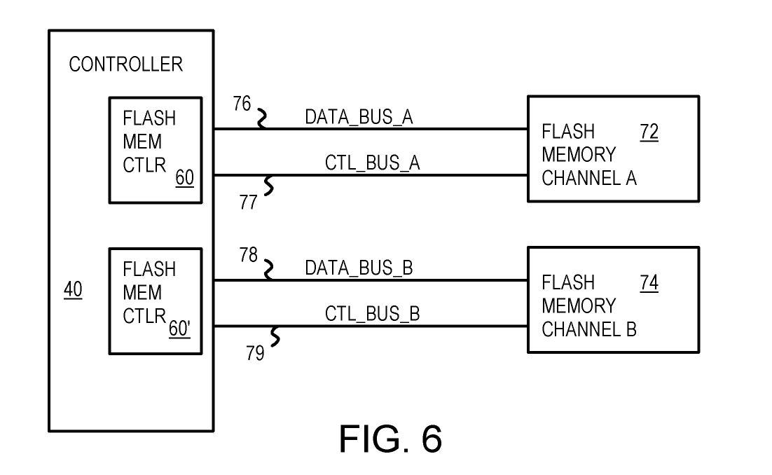

FIG. 6 shows two channels between the flash controller and the flash-memory chips on the ExpressCard. Controller 40 is the primary controller chip on the ExpressCard and contains two flash controllers 60, 60′, which generate external signals to the flash-memory chips. The flash-memory chips are arranged into two channels: flash-memory channel A 72 and flash-memory channel B 74.

The flash bus to the flash-memory chips from flash controllers 60, 60′ can be divided into two separate channels. Data bus A 76 carries 8 bits of data to and from one or more flash-memory chips in flash-memory channel A 72, while data bus B 78 carries 8 bits of data to and from one or more flash-memory chips in flash-memory channel B 74. Control signals in the flash bus are also divided into two channels. Control bus A 77 contains flash-chip-specific control signals for flash-memory channel A 72, while control bus B 79 contains flash-chip-specific control signals for flash-memory channel B 74. More channels could be added.

Flash-chip-specific control signals that can include chip-select, read and write enables, and address and command latch-enable signals. A write-protect signal may be tied to a fixed voltage and read by controller 40 through an I/O or input port.

Having separate channels to flash-memory chips allows for higher bandwidth transfers to and from the flash-memory chips, helping to improve the operating speed of the flash-memory ExpressCard. Dual flash channels and their higher data bandwidth are especially useful with higher-bandwidth protocols such as USB 2.0, since front and back end data rates are better matched.

Data stored to the two flash-memory channels could be interleaved, either at a low-level of one or more data bytes or at higher levels such as sectors, pages, or blocks. Alternate sectors, pages, or blocks are stored in alternating flash-memory channels to improve bandwidth. Erase operations could also be interleaved.

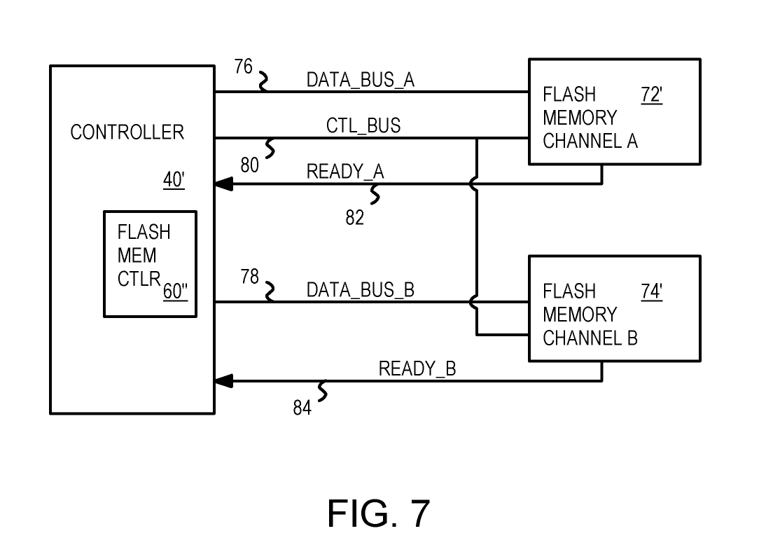

FIG. 7 shows two channels of flash-memory chips with a shared control bus but separate ready lines. The flash-memory chips are arranged into two channels: flash-memory channel A 72′ and flash-memory channel B 74′, but more channels could be used. Controller 40′ contains flash controller 60″ that supports two or more flash-bus channels.

Most control signals in the flash bus are shared among the two channels. Control bus 80 contains most of the flash-chip-specific control signals for flash-memory channel A 72′ and for flash-memory channel B 74′. When addresses and commands are sent through the data bus, the address or command values can be duplicated to both of data bus_A 76 and data bus_B 78.

Since flash-memory chips may differ in response times, such as the amount of time or delay to complete an erase, a write, or a read, the ready signal from different flash-memory chips may be generated at different times even when flash operations are started at the same time.

For example, a read operation to flash-memory chips in both channels 72′, 74′ may be initiated at the same time by a command duplicated in both data buses and followed by a read-enable signal in control bus 80 that is shared and applied to both flash-memory chips in channels 72′, 74′ once the data is ready. However, the flash-memory chip being accessed in flash-memory channel A 72′ is faster than the flash-memory chip being accessed in flash-memory channel B 74′. The channel A ready signal from the flash-memory chip in flash-memory channel A 72′ is returned first on ready line 82. Later, perhaps several clock cycles later, the channel B ready signal from the flash-memory chip in flash-memory channel B 74′ is returned on ready line 84.

Separate ready lines 82, 84 allow data to be transferred at a pace determined by the slower chip of the flash-memory chips. Data bus A 76 carries 8 bits of data to and from one or more flash-memory chips in flash-memory channel A 72′, while data bus B 78 carries 8 bits of data to and from one or more flash-memory chips in flash-memory channel B 74′. Together the two bytes from the two flash channels can form a 16-bit data bus.

Having two channels allows for a larger page size and a wider data bus, increasing bandwidth.

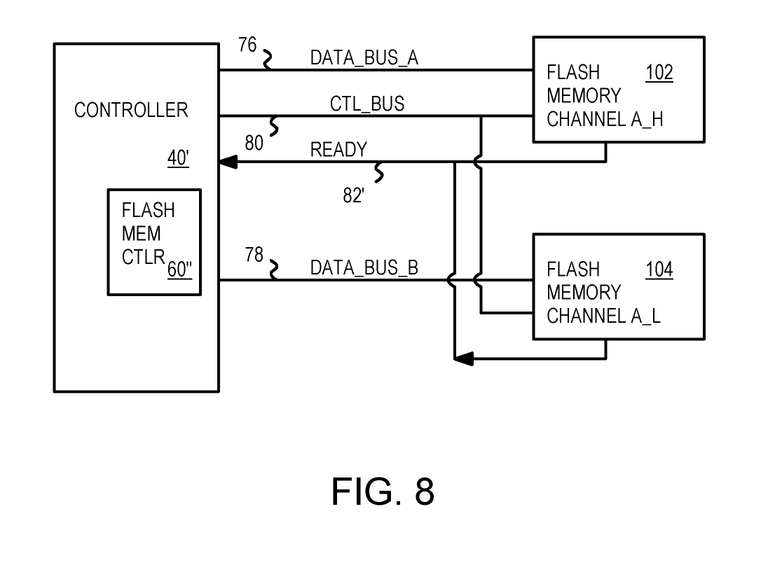

FIG. 8 shows an embodiment using open-drain ready lines. Some flash-memory chips may have open-drain ready lines, allowing them to share the same ready line and assert ready at different times. Ready line 82′ connects to both flash memory chips. Since shared control bus 80 and ready line 82′ connect to both flash memory chips 102, 104, they act as one logical channel. For example, flash memory chip 102 can have upper bits 8-16 while flash memory chip 104 has lower bits 0-7.

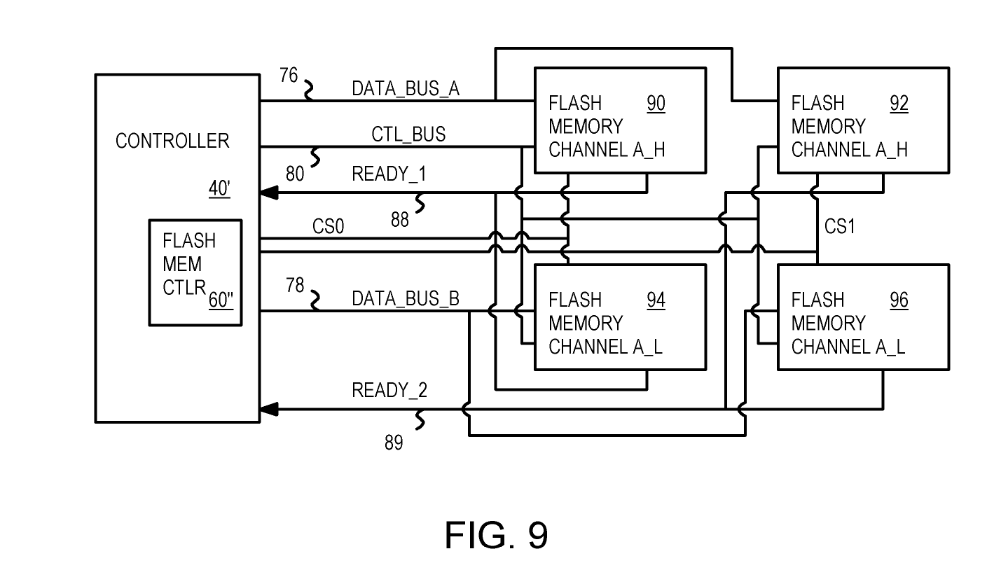

FIG. 9 shows an embodiment with four flash-memory chips in one logical channel with interleaving. Shared control bus 80 connects to all four flash memory chips 90, 92, 94, 96. However, Ready_1 88 connects to a first interleave of chips 90, 94 while Ready_2 89 connects to a second interleave of chips 92, 96. Chips 90, 94 are accessed together since they share chip-select CS0. Chips 92, 96 are accessed together since they share chip-select CS1. Flash-memory chips 90, 92 are in the upper portion of the data bus, or channel A_H, and receive data bus A, while flash-memory chips 94, 96 are in the lower portion of the data bus, or channel A_L, and receive data bus B. Ready_1 88 is driven by a first interleave of flash memory chips 90, 94, which are activated by chip-select CS0. Ready_2 89 is driven by a second interleave of flash memory chips 92, 96, which are activated by chip-select CS1. The interleaves thus include flash-memory chips in both upper and lower bits of the data bus. Interleaving can improve throughput since one interleave's chips can begin access while the other interleave's chips are finishing an access. For example, access can begin to the second interleave of chips 92, 96 while access is completing for the first interleave of chips 90, 94.

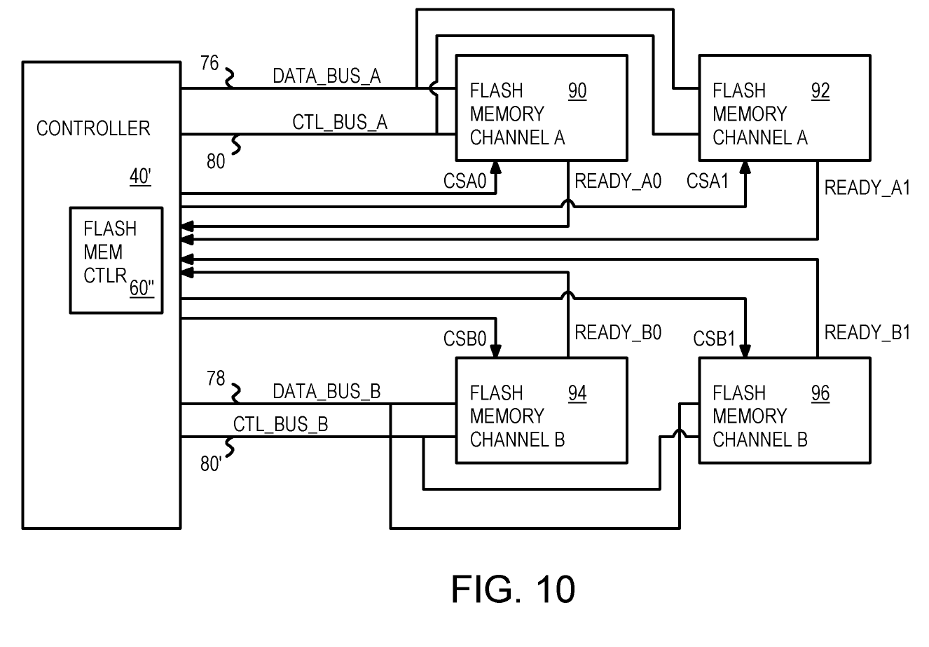

FIG. 10 shows another embodiment with two independent channels and interleaving within each channel. Data bus A 76 and control bus A 80 connect to flash-memory chips 90, 92 in channel A. Data bus B 78 and control bus B 80′ connect to flash-memory chips 94, 96 in channel B. Since separate control signals are applied to chips in each channel, the channels can be operated independently of each other.

Each flash-memory chip 90, 92, 94, 96 is controlled by its own dedicated chip-select signal CSA0, CSA1, CSB0, CSB1, respectively. Each flash-memory chip 90, 92, 94, 96 generates a separate ready signal Ready_A0, Ready_A1, Ready_B0, Ready_B1, respectively. Controller 60″ can operate each channel independently of one another. Furthermore, operation and chips 90, 92 in channel A can be interleaved by starting an operation or access to one chip 90 and then starting an operation or access to the other chip 92 before chip 90 has completed its operation. Likewise, operation or access of chips 94, 96 in channel B can be interleaved.

### ALTERNATE EMBODIMENTS

Several other embodiments are contemplated by the inventor. For example controllers and functions can be implemented in a variety of ways. Functions can be programmed and executed by the CPU, or can be implemented in dedicated hardware, or in some combination. The ROM could be updateable, and some program code could be located in the RAM rather than the ROM. Some program code may be located in the flash memory chips and is uploaded to RAM when needed. Wider or narrower data buses and flash-memory chips could be substituted, such as 16 or 32-bit data channels. Alternate bus architectures with nested or segmented buses could be used internal or external to the controller. The ready line may be a busy or a not-busy line, and may be active high or low.

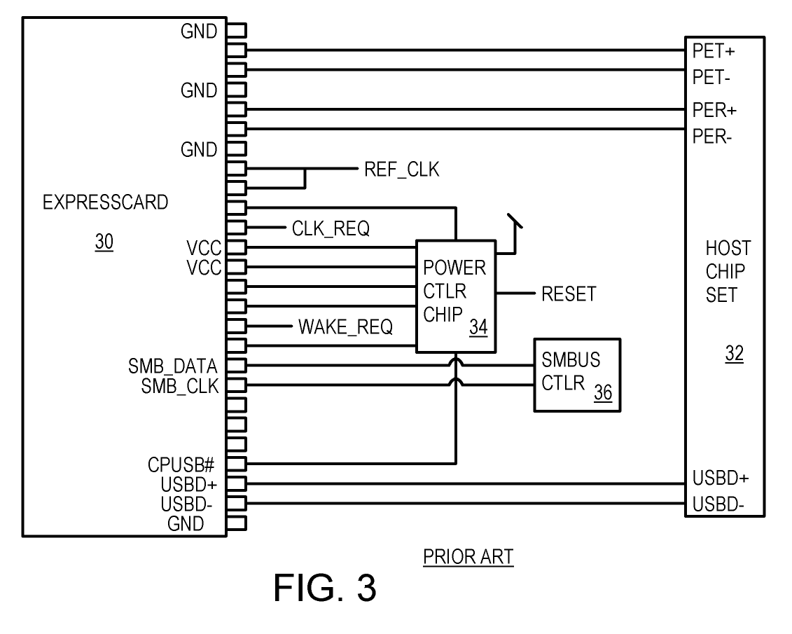

Rather than use USB for transfers, controller 40 of FIG. 4 could use other protocols, such as PCI Express, Firewire (IEEE 1394), serial ATA, serial attached small-computer system interface (SCSI), etc. Different signals in the ExpressCard connector could be used for the different protocols with a different serial engine. For example, PCI Express can use the PET and PER signals in FIG. 3. A dual-mode controller could also be substituted for controller 40. Rather than have only a USB serial engine, a second serial engine could be added. The second serial engine connects to the PET and PER lines and follows the PCI Express protocol when communicating with the host through the ExpressCard connector.

Rather than have all flash-memory chips mounted directly on a board or other substrate in the ExpressCard, pairs of flash-memory chips can be stacked together in some embodiments. One flash-memory chip is directly put on top of another flash-memory chip. A very thin conducting material may be used for connections between the two flash-memory chips. The conventional flash-memory chip package has electrical signal leads (pins) and No Connect (NC) leads (pins). An NC pin has no electrical connection within the flash-memory chip package. All the respective electrical signals except the chip-select (CS) signal of each flash memory chip can share the same electrical lines. The flash memory chips can be put on top of each other with all corresponding pins soldered to each other. However, the top chip's CS pin signal is re-routed to a NC lead on the bottom flash-memory chip and then to the substrate or printed-circuit board (PCB). Two or more flash chips can thus be stacked at one flash chip location on the board.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 C.F.R. sect. 1.72(b). Any advantages and benefits described may not apply to all embodiments of the invention. When the word “means” is recited in a claim element, Applicant intends for the claim element to fall under 35 USC sect. 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An ExpressCard comprising:
an ExpressCard connector for mating with a host ExpressCard connector on a host;
a first flash-memory chip for storing data;
a second flash-memory chip for storing data;
a controller chip, coupled to the ExpressCard connector, for controlling communication to the host through the ExpressCard connector;
a first flash-memory channel between the controller chip and the first flash-memory chip, the first flash-memory channel having a first data bus for communicating data between the controller chip and the first flash-memory chip;
a second flash-memory channel between the controller chip and the second flash-memory chip, the second flash-memory channel having a second data bus for communicating data between the controller chip and the second flash-memory chip;
a shared control bus between the controller chip and the first and second flash-memory chips;
a first response line from the first flash-memory chip to the controller chip for indicating completion of an operation by the first flash-memory chip; and
a second response line from the second flash-memory chip to the controller chip for indicating completion of an operation by the second flash-memory chip,
whereby the ExpressCard has two channels to the first and second flash-memory chips but a shared control bus to the first and second flash-memory chips.

2. The ExpressCard of claim 1 further comprising:
a housing for enclosing the controller chip and the first and second flash-memory chips;
wherein the housing has an opening on an insertion end for the ExpressCard connector.

3. The ExpressCard of claim 2 wherein the housing contains a cutout notch wherein a first width of the insertion end containing the ExpressCard connector is narrower than a second width of an opposite end that is opposite the insertion end.

4. The ExpressCard of claim 2 wherein the first response line carries a ready signal from the first flash-memory chip;
wherein the second response line carries a ready signal from the second flash-memory chip,
whereby separate ready signals are sent to the controller chip.

5. The ExpressCard of claim 4 wherein the controller chip further comprises:
a serial engine, coupled to the ExpressCard connector, for sending and receiving serial signals representing data and commands from the host;
a flash-memory controller for generating control signals on the shared control bus to the first and second flash-memory chips;
a central processing unit (CPU) for executing routines of instructions to transfer data between the serial engine and the flash-memory controller.

6. The ExpressCard of claim 5 wherein the controller chip further comprises
an internal bus between the CPU, the serial engine, and the flash-memory controller.

7. The ExpressCard of claim 5 wherein the controller chip further comprises:
a system buffer for temporarily storing data transferred between the serial engine and the flash-memory controller;
a scratch-pad random-access memory (RAM) for storing parameters used by the CPU; and
a read-only memory (ROM) for storing the routines of instructions executed by the CPU.

8. The ExpressCard of claim 5 wherein the controller chip further comprises:
an error-correction code (ECC) generator, coupled to the flash-memory controller, for appending ECC bits to data being written to the first or second flash-memory chips, and for reading ECC bits and correcting errors in data read from the first or second flash-memory chips, whereby data errors are corrected by error-correction code.

9. The ExpressCard of claim 5 wherein the routines of instructions include routines to erase, read, or write data in the first or second flash-memory chips.

10. The ExpressCard of claim 9 wherein the controller chip further comprises:
an input-output interface for driving an indicator lamp when the flash-memory controller is reading or writing to the first or second flash-memory chips.

11. The ExpressCard of claim 5 wherein the shared control bus comprises a read-enable signal and a write-enable signal that are connected to both the first and second flash-memory chips.

12. The ExpressCard of claim 11 wherein the shared control bus further comprises:
a command latch enable signal to latch a command into the first or second flash-memory chips;
an address latch enable signal to latch an address into the first or second flash-memory chips.

13. The ExpressCard of claim 12 wherein the shared control bus comprises a shared chip-select signal to enable the first flash-memory chip and the second flash-memory chip.

14. The ExpressCard of claim 5 wherein the ExpressCard connector has a pair of differential data lines for communicating data and commands from the host to the controller chip.

15. The ExpressCard of claim 14 wherein the pair of differential data lines comprise Universal-Serial-Bus (USB) data lines, wherein the controller chip is a USB slave and the host is a USB host.

16. A flash-storage ExpressCard comprising:
connector means for connecting to a host;
controller means for performing control functions;
flash-memory means for storing data in non-volatile memory;
a first channel between the controller means and the flash-memory means, the first channel having a first data bus and a first ready means for indicating when a first flash-memory chip in the flash-memory means is busy;
a second channel between the controller means and the flash-memory means, the second channel having a second data bus and a second ready means for indicating when a second flash-memory chip in the flash-memory means is busy;
shared control bus means for sending flash control signals to flash-memory means;
flash-control means, in the controller means, for generating the flash control signals to the shared control bus means; and
serial control means, in the controller means, for serially communicating with the host through the connector means.

17. The flash-storage ExpressCard of claim 16 wherein the serial control means comprises a Universal-Serial-Bus (USB) controller, and wherein the connector means includes a differential pair of serial data lines that carry serial USB signals between the host and the controller means, or
wherein the serial control means comprises a Peripheral Component Interconnect (PCI) Express controller, and wherein the connector means includes a differential pair of PCI-Express-transmit serial data lines and a differential pair of PCI-Express-receive serial data lines that carry serial signals between the host and the controller means.

18. The flash-storage ExpressCard of claim 16 wherein the serial control means comprises both a Universal-Serial-Bus (USB) controller, and a Peripheral Component Interconnect (PCI) Express controller;
and wherein the connector means includes a differential pair of serial data lines that carry serial USB signals between the host and the controller means when using the USB controller, and a differential pair of PCI-Express-transmit serial data lines and a differential pair of PCI-Express-receive serial data lines that carry serial signals between the host and the controller means when using the PCI Express controller,
whereby dual serial controllers allow communication with the host using either USB or PCI Express.

19. An interleaved flash ExpressCard comprising:
an ExpressCard connector for plugging into a host;
a controller chip that has a microprocessor core, a program memory, a buffer memory, a serial controller, and a flash controller;
a first flash-memory chip in a first channel;
a second flash-memory chip in the first channel;
a third flash-memory chip in the first channel;
a fourth flash-memory chip in the first channel;
a shared control bus having a write-enable signal, a read-enable signal, and latch-enable signals generated by the flash controller in the controller chip and driven to the first, second, third, and fourth flash-memory chips;
a first data bus between the controller chip and the first and third flash-memory chip;
a first shared ready signal generated by the first flash-memory chip and the second flash-memory chip and driven to the controller chip;
a second data bus between the controller chip and the second and fourth flash-memory chip; and
a second shared ready signal generated by the third flash-memory chip and the fourth flash-memory chip and driven to the controller chip;
a first chip select generated by the controller chip and connected to the first and second flash-memory chip;
a second chip select generated by the controller chip and connected to the third and fourth flash-memory chip;
wherein the serial controller in the controller chip is a Universal-Serial-Bus (USB) controller that communicates to the host using a pair of differential USB data signals in the ExpressCard connector, or the serial controller in the controller chip is a Peripheral Component Interconnect (PCI) Express controller, a Firewire controller, a serial ATA controller, or a serial small-computer system interface (SCSI) controller;
wherein access to the first and third flash-memory chips is interleaved;
wherein access to the second and fourth flash-memory chips is interleaved.

20. An interleaved dual-channel flash ExpressCard comprising:
an ExpressCard connector for plugging into a host;
a controller chip that has a microprocessor core, a program memory, a buffer memory, a serial controller, and a flash controller;
a first flash-memory chip in a first channel;
a second flash-memory chip in a second channel;
a third flash-memory chip in the first channel;
a fourth flash-memory chip in the second channel;
a first shared control bus having a write-enable signal, a read-enable signal, and latch-enable signals generated by the flash controller in the controller chip and driven to the first and third flash-memory chips;
a first data bus between the controller chip and the first and third flash-memory chip;
a first ready signal generated by the first flash-memory chip and driven to the controller chip;
a third ready signal generated by the third flash-memory chip and driven to the controller chip;
a second shared control bus having a write-enable signal, a read-enable signal, and latch-enable signals generated by the flash controller in the controller chip and driven to the second and fourth flash-memory chips;
a second data bus between the controller chip and the second and fourth flash-memory chip; and
a second ready signal generated by the second flash-memory chip and driven to the controller chip; and
a fourth ready signal generated by the fourth flash-memory chip and driven to the controller chip;
wherein the serial controller in the controller chip is a Universal-Serial-Bus (USB) controller that communicates to the host using a pair of differential USB data signals in the ExpressCard connector, or the serial controller in the controller chip is a Peripheral Component Interconnect (PCI) Express controller, a Firewire controller, a serial ATA controller, or a serial small-computer system interface (SCSI) controller,
wherein access to the first and third flash-memory chips is interleaved;
wherein access to the second and fourth flash-memory chips is interleaved.
